(19) United States
(12) Patent Application Publication
(10) Pub. No.: US 2012/0071035 A1
(43) Pub. Date: Mar. 22, 2012

(54) CAGE TERMINAL FOR AN ELECTRIC DEVICE AND AN ELECTRIC DEVICE USING THE SAME

(75) Inventors: Chun HE, Mu Du (CN); Guo Zhi SUN, New District (CN); Yan YIN, Pudong Area (CN)

(73) Assignee: SIEMENS AKTIENGESELLSCHAFT, Munich (DE)

(21) Appl. No.: 13/236,103

(22) Filed: Sep. 19, 2011

(30) Foreign Application Priority Data
Sep. 20, 2010 (CN) 201010295150.1

(51) Int. Cl. H01R 4/36; H01R 4/28

(52) U.S. Cl. 439/810; 439/775

(57) ABSTRACT

A cage terminal is disclosed for an electric device, the cage terminal, in at least one embodiment, being detachably connected to the electric device and pressing a wire detachably onto a connecting tab of the electric device. In at least one embodiment, it does not need to develop different products of electric device with the same body but different wired terminals, and it is convenient for the electric device to change different terminals, thus reducing the development, production and use costs of the electric device and facilitating the operation thereof.

### PRIORITY STATEMENT

The present application hereby claims priority under 35 U.S.C. §119 on Chinese patent application number CN 201010295150.1 filed Sep. 20, 2010, the entire contents of which are hereby incorporated herein by reference.

### FIELD

At least one embodiment of the present invention generally relates to a cage terminal for an electric device and an electric device using the same.

### BACKGROUND

Electric devices need to connect to cables or buses via terminals when they are connected. The electric devices with different connection modes (such as bolt terminal or cage terminal) are selected according to the requirements of particular application situations and users' preferences. Then, there is a need to develop different electric device products with different connection terminals but the same device body. Usually, this would require additional equipment (such as molds) and additional processing steps, which therefore increases the development and production costs for such electric devices. At the same time, these terminals and the electric devices form an inseparable whole, and when there is a need to employ another type of terminal to replace the currently available terminals, it would be necessary to replace the body of the electric device as well.

### SUMMARY

At least one embodiment of the present invention provides a cage terminal, which is interchangeable with other terminals, especially a bolt terminal, and an electric device using the same.

In at least one embodiment, a cage terminal is disclosed for an electric device. The cage terminal is detachably connected to the electric device and is capable of detachably pressing a wire onto a connecting tab of the electric device.

At least one embodiment is further directed to an electric device including a connection terminal of at least one embodiment of the present invention as described above. One end of the electric device includes a first connecting tab and a first slot, with the first connecting tab being electrically connected to the body of the electric device and inserted into the metal frame. The first slot is located on the housing of the electric device. The snap part is snap-fitted within the first slot.

Advantages of at least one embodiment of the present invention can include: it does not need to develop different electric device products with the same device body but different connection terminals, and it is convenient to change different terminals for an electric device, thus reducing the development, production and use costs of the electric device and facilitating the operation.

### BRIEF DESCRIPTION OF THE DRAWINGS

The features and advantages of embodiments of the present invention will be made more apparent in conjunction with the following drawings, in which the same reference numbers indicate the same components:

FIG. 1 illustrates the exploded components of a cage terminal 1 of the present invention;

FIG. 2 illustrates a perspective view of the cage terminal 1 and an electric device 2 of the present invention during their assembly;

FIG. 3 illustrates a partial sectional view of the cage terminal 1 and the electric device 2 of the present invention after having been assembled; and

FIG. 4 illustrates another way for implementing a snap part 113 and a first slot 22.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

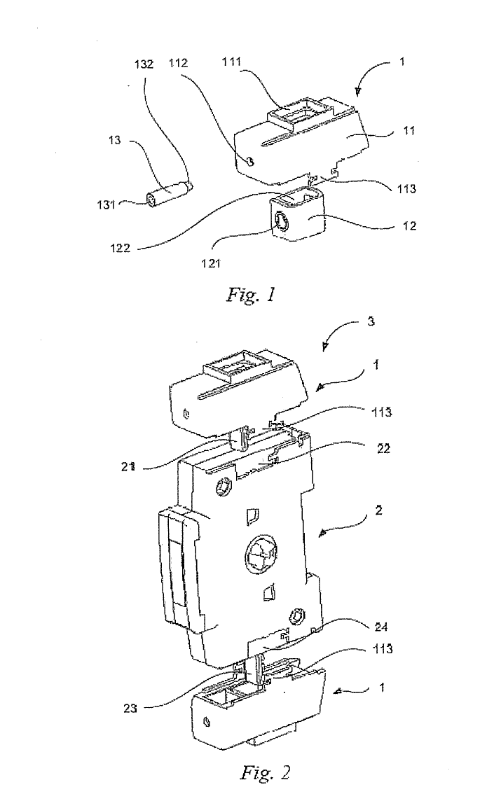

FIG. 1 illustrates an exploded cage terminal 1 of an embodiment of the present invention, which includes a housing 11, a metal frame 12 and a screw 13. The housing 11 has a connection port 111, a screw hole 112 and a snap part 113, in which the connection port 111 and the screw hole 112 are located respectively on two intersectional planes of the housing 11 and preferably on two mutually perpendicular planes. The metal frame 12 has a through hole 122 which is in communication with the connection port 111 and an abutting part 121 on the side wall facing the screw hole 112. One end of the screw 13 has a driving part 131 and the other end has a locating part 132. The driving part 131 is an internal hexagonal hole, and the locating part 132 is a boss, in which the diameter of the boss is smaller than that of the screw 13.

FIG. 2 illustrates the cage terminal 1 and an electric device 2 of an embodiment of the present invention during their assembly, in which the electric device 2 is one with a plastic housing, such as a low voltage breaker, a contact pole of a disconnecting switch, etc. The electric device 2 has a first connecting tab 21 and a second connecting tab 23 for achieving electric connection between the electric device 2 and an external circuit. The connecting tab 21 in FIG. 2 has been partly inserted into the metal frame 12. The snap parts 113 of two cage terminals 1 can be snap-fitted into the first slot 22 and the second slot 24 on the housing of the electric device 2 respectively so that the cage terminal 1 is detachably connected to the electric device 2. Though the electric device 2 in FIG. 2 is connected to two cage terminals 1, it should be understood by those skilled in the art that it can be connected to only one cage terminal 1 according to practical requirements.

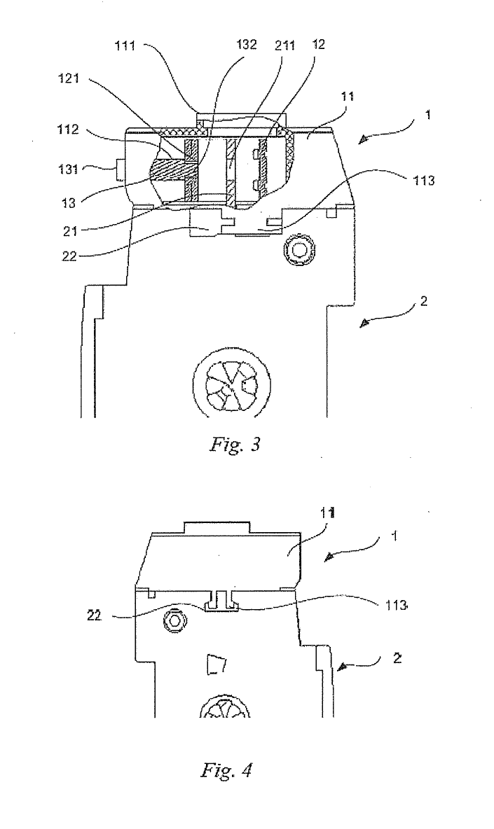

FIG. 3 illustrates a partial sectional view of the cage terminal 1 and the electric device 2 of an embodiment of the present invention after having been assembled. The connection port 111 allows the cables to be connected thereto to go in and come out the cage terminal 1. The metal frame 12 is located in the housing 11 and is slidable within the housing 11. The connecting tab 21 is inserted into the metal frame 12, and there is a gap between it and the side wall of the metal frame 12 to allow the cables to enter.

The screw 13 has an external thread matching the internal thread of the screw hole 112. The boss of the locating part 132 of the screw 13 can be located in a hole of the abutting part 121, while the shoulder of the boss abuts against the periphery of the hole in the abutting part 121. The screw 13 can be screwed into the screw hole 112 and abuts against the abutting part 121 by rotating a tool (not shown) inserted into the hexagonal hole.

When making a connection, the cables are first inserted into the gap between the connecting tab 21 and the metal frame 12, then the screw 13 is rotated to push the metal frame 12 to slide in the housing 11 until the abutting part 121 presses the cables tightly onto the connecting tab 21. When an operator wants to use a bolt terminal (not shown) for the connection, he only needs to rotate the screw 13 in the opposite direction to take out the cables and open the snap part 113 to detach the cage terminal 1 from the electric device 2, thus exposing the connecting tab 21. The connecting tab 21 has a round hole 211 into which a bolt can be inserted, and it only needs to fit the bolt in the round hole 211 to make a connection. According to an implementation of an embodiment of the present invention, there is a spring (not shown) between the opposing side of the abutting part 131 and the inner side of the housing 11, the spring force of which pushes the metal frame 12 towards the screw hole 112.

FIG. 4 illustrates another implementation of the snap part 113 and the first slot 22, in which the snap part 113 and the first slot 22 cooperate by using a bolt lock mechanism instead of the slot and tenon mechanism as shown in FIG. 3. Those skilled in the art would understand that the cooperation of the snap part and the slot can be achieved on both sides of the electric device and the cooperation of the snap part and the slot can also be achieved only on one side of the electric device.

In an embodiment, a cage terminal is disclosed for an electric device. The cage terminal is detachably connected to the electric device and is capable of detachably pressing a wire onto a connecting tab of the electric device.

According to one aspect of an embodiment of the present invention, the cage terminal includes a housing. The housing has a connection port, a screw hole and a snap part, with the connection port and the screw hole being located respectively on two intersectional planes of the housing.

According to another aspect of an embodiment of the present invention, the cage terminal includes a metal frame, and the metal frame is located in the housing and includes an abutting part and a through hole, with the through hole communicating with the connection port. The metal frame is slidable within the housing.

According to yet another aspect of an embodiment of the present invention, the cage terminal includes a screw, one end of the screw includes a driving part and the other end includes a locating part, and the screw includes an external thread matching the internal thread of the screw hole. The screw is screwed into the screw hole, and the locating part abuts against the abutting part.

According to yet another aspect of an embodiment of the present invention, the connection port and the screw hole are located respectively on two mutually perpendicular planes of the housing.

According to yet another aspect of an embodiment of the present invention, there is a spring between the opposing side of the abutting part and the inner side of the housing.

According to yet another aspect of an embodiment of the present invention, the driving part includes an internal hexagonal hole.

According to yet another aspect of an embodiment of the present invention, the locating part is a boss, with the shoulder of the boss abutting against the abutting part.

An embodiment is further directed to an electric device including a connection terminal of at least one embodiment of the present invention as described above. One end of the electric device includes a first connecting tab and a first slot, with the first connecting tab being electrically connected to the body of the electric device and inserted into the metal frame. The first slot is located on the housing of the electric device. The snap part is snap-fitted within the first slot.

According to one aspect of an embodiment of the present invention, the other end of the electric device includes a second connecting tab and a second slot and includes another one of the connection terminal. The second connecting tab is electrically connected to the body of the electric device and inserted into the metal frame of the other one of the connection terminal. The second slot is located on the housing of the electric device and the snap part of the other one of the connection terminal is snap-fitted in the second slot.

Advantages of an embodiment of the present invention can include: it does not need to develop different electric device products with the same device body but different connection terminals, and it is convenient to change different terminals for an electric device, thus reducing the development, production and use costs of the electric device and facilitating the operation.

Although the implementation of an embodiment of the present invention is illustrated above, the implementation is not intended to illustrate all possible forms of embodiments of the present invention. Furthermore, the contents in this description are illustrative instead of restrictive. Various alternations and modifications can be made to the contents of the present invention by those skilled in the art without departing from the subject matter of the present invention and the scope of the claims.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A cage terminal for an electric device, said cage terminal being detachably connected to the electric device and being capable of detachably pressing a wire onto a connecting tab of the electric device.

2. The cage terminal as claimed in claim 1, further comprising:
a housing, the housing including a connection port, a screw hole and a snap part, said connection port and said screw hole being located on two intersectional planes of said housing respectively.

3. The cage terminal as claimed in claim 2, further comprising:
a metal frame, said metal frame being located in said housing and including an abutting part and a through hole, said through hole being in communication with said connection port, and said metal frame being slidable in said housing.

4. The cage terminal as claimed in claim 3, further comprising:
a screw, one end of said screw including a driving part and the other end including a locating part and said screw including an external thread matching the internal thread of said screw hole; said screw being screwed into said screw hole and said locating part abutting against said abutting part.

5. The cage terminal as claimed in claim 2, wherein said connection port and said screw hole are located respectively on two mutually perpendicular planes of said housing.

6. The cage terminal as claimed in claim 3, further comprising:
a spring, between an opposing side of said abutting part and an inner side of said housing.

7. The cage terminal as claimed in claim 4, wherein said driving part includes an internal hexagonal hole.

8. The cage terminal as claimed in claim 4, wherein said locating part is a boss, with a shoulder of said boss abutting against said abutting part.

9. An electric device, comprising:
a connection terminal as claimed in claim 1, one end of said electric device including a first connecting tab and a first slot, said first connecting tab being electrically connected to a body of said electric device and being inserted into said metal frame; and said first slot being located on the housing of said electric device and said snap part being snap-fitted within said first slot.

10. The electric device as claimed in claim 9, wherein the other end of said electric device includes a second connecting tab and a second slot and includes another one of said connection terminal, said second connecting tab being electrically connected to the body of said electric device and inserted into said metal frame of the another one of said connection terminal, said second slot being located on the housing of said electric device, and said snap part of the other one of said connection terminal being snap-fitted within said second slot.

11. An electric device, comprising:
a connection terminal as claimed in claim 2, one end of said electric device including a first connecting tab and a first slot, said first connecting tab being electrically connected to a body of said electric device and being inserted into said metal frame; and said first slot being located on the housing of said electric device and said snap part being snap-fitted within said first slot.

12. The electric device as claimed in claim 11, wherein the other end of said electric device includes a second connecting tab and a second slot and includes another one of said connection terminal, said second connecting tab being electrically connected to the body of said electric device and inserted into said metal frame of the another one of said connection terminal, said second slot being located on the housing of said electric device, and said snap part of the other one of said connection terminal being snap-fitted within said second slot.

13. An electric device, comprising:
a connection terminal as claimed in claim 3, one end of said electric device including a first connecting tab and a first slot, said first connecting tab being electrically connected to a body of said electric device and being inserted into said metal frame; and said first slot being located on the housing of said electric device and said snap part being snap-fitted within said first slot.

14. The electric device as claimed in claim 13, wherein the other end of said electric device includes a second connecting tab and a second slot and includes another one of said connection terminal, said second connecting tab being electrically connected to the body of said electric device and inserted into said metal frame of the another one of said connection terminal, said second slot being located on the housing of said electric device, and said snap part of the other one of said connection terminal being snap-fitted within said second slot.
